(19) United States
(12) Patent Application Publication
(10) Pub. No.: US 2008/0073919 A1
(43) Pub. Date: Mar. 27, 2008

(54) DOOR-LOCKING KNOB CONSTRUCTION OF VEHICLE

(75) Inventor: Masaki Soda, Utsunomiya-shi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/855,458

(22) Filed: Sep. 14, 2007

(30) Foreign Application Priority Data
Sep. 26, 2006 (JP) 2006-260886

(51) Int. Cl. E05B 3/00; E05B 17/00; E05B 65/20

(52) U.S. Cl. 292/336.3

(57) ABSTRACT

This door-locking knob construction of a vehicle is provided in an inside of a vehicular door. A door-locking knob is rotationally provided in a knob-installation portion inside the vehicular door, and switches between a locking and an unlocking of a door-locking mechanism in accordance with a rotational position thereof. The door-locking knob is provided with a lock face which is continuous with a surface of the knob-installation portion while in a locking position, and an unlock face which is continuous with the lock face and is exposed to the same side as the surface of the knob-installation portion while in an unlocking position. The unlock face is formed in a substantial arc shape centering on a rotational axis of the door-locking knob. A gap between the knob-installation portion and the unlock face is maintained to be a predetermined small width, in a rotational range between the locking position and the unlocking position.

Priority is claimed on Japanese Patent Application No. 2006-260886, filed Sep. 26, 2006, the contents of which are incorporated herein by reference.

### BACKGROUND OF THE INVENTION

1. Field of the Invention

The present invention relates to a door-locking knob construction of a vehicle.

2. Description of the Related Art

Normally, each doors of a vehicle is provided with a door-locking knob for switching between a locking state and an unlocking state of a door-locking mechanism. In this kind of door-locking knobs, there is a rotational type door-locking knob which switches between a locking position and an unlocking position by rotating the door-locking knob (for example, refer to Japanese Unexamined Patent Application, First Publication No. H09-303001).

As shown in FIG. 5, the conventional rotational type door-locking knob 90 is rotatably installed via a supporting pin 91 in a knob-installation portion 100 inside a door. An operation portion 92 of the door-locking knob 90 is exposed to the cabin interior side through an opening of the knob-installation portion 100. By operating the operation portion 92, the door-locking knob 90 can be rotated between the unlocking position indicated by solid lines and the locking position indicated by two-dotted lines.

When the door-locking knob 90 is in the unlocking position, a closing end face 93 of the operation portion 92 is away from an end face 102 in an opening 101, and a marking 94 formed on the closing end face 93 is exposed to the cabin interior side so as to be visible. On the other hand, when the door-locking knob 90 is in the locking position, the closing end face 93 of the operation portion 92 approaches and faces the end face 102 in the opening 101, and the marking 94 formed on the closing end face 93 becomes invisible.

However, in the conventional rotational type door-locking knob construction, when the door-locking knob 90 is in the unlocking position, a gap 95 is formed between the closing end face 93 of the operation portion 93 and the end face 102 in the opening 101. Therefore, while operating from the unlocking position to the locking position, there is a possibility of sandwiching an object in this gap 95.

In addition, when the door-locking knob 90 is in the unlocking position, the marking 94 is seen by an occupant in a slanted manner; therefore, the visibility thereof is not good.

In view of the above-mentioned circumstances, the present invention has an object of providing a door-locking knob construction of a vehicle, which can prevent sandwiching an object while operating it. Furthermore, the present invention has an object of providing a door-locking knob construction of a vehicle, having a marking which can be easily seen by an occupant while in an unlocking position.

### SUMMARY OF THE INVENTION

The present invention employed the followings in order to achieve the above-mentioned object.

That is, the present invention employs a door-locking knob construction of a vehicle, provided in an inside of a vehicular door, wherein: a door-locking knob is rotationally provided in a knob-installation portion inside the vehicular door, and switches between a locking and an unlocking of a door-locking mechanism in accordance with a rotational position thereof; the door-locking knob includes a lock face which is continuous with a surface of the knob-installation portion while in a locking position, and an unlock face which is continuous with the lock face and is exposed to the same side as the surface of the knob-installation portion while in an unlocking position; the unlock face is formed in a substantial arc shape centering on a rotational axis of the door-locking knob; and a gap between the knob-installation portion and the unlock face is maintained to be a predetermined small width, in a rotational range between the locking position and the unlocking position.

According to the door-locking knob construction of a vehicle, while operating the door-locking knob from the unlocking position to the locking position, it is possible to prevent an object from being sandwiched between the door-locking knob and the knob-installation portion.

It may be arranged such that: the unlock face includes a marking thereon which indicates the unlocking position; and the marking faces a cabin interior side when the door-locking knob is in the unlocking position.

In this case, since the visibility of the marking can be improved, it is possible to reliably distinguish whether the door-locking mechanism is in the locking state or in the unlocking state.

The marking may be provided in a dented portion provided in the unlock face, and may have a planar surface.

In this case, since the visibility of the marking can be further improved, it is possible to further reliably distinguish whether the door-locking mechanism is in the locking state or in the unlocking state.

The knob-installation portion may have a clearance which is formed along a rotational trajectory of the unlock face.

In this case, it is possible to continuously form a gap having the small width, between the unlock face and the knob-installation portion. Therefore, it is possible to prevent light getting into the gap, and thereby making the deep inside of the gap invisible. Accordingly, the commercial value thereof can be increased.

The predetermined small width may be within a range between 0.5 mm to 1.5 mm.

### BRIEF DESCRIPTION OF THE DRAWINGS

FIG. 1 is a perspective view seen from a cabin interior side, of a door provided with a door-locking knob construction of a vehicle according to one embodiment of the present invention.

FIG. 2 is a perspective view of an inner handle case provided with a door-locking knob positioned in a locking position.

FIG. 3 is a perspective view of the door-locking knob in an unlocking position.

FIG. 4 is a cross-sectional view taking along a line A-A of FIG. 3.

FIG. 5 is a cross-sectional view of a conventional door-locking knob construction, which corresponds to FIG. 4.

### DETAILED DESCRIPTION OF THE INVENTION

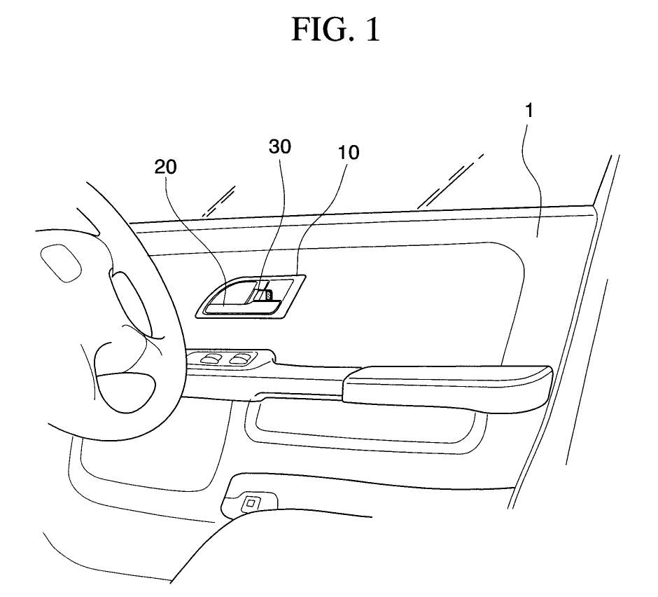

One embodiment of a door-locking knob construction of a vehicle according to the present invention will be explained below with reference to FIGS. 1 to 4. Moreover, in the following explanation, the forward and the rearward correspond to the forward and the rearward of a vehicle body.

FIG. 1 is a view of a door 1 on a driver's seat side of the vehicle, seen from the cabin interior side. An inner handle case (a knob-installation portion) 10 provided with an inner handle 20 and a door-locking knob 30 is installed on the cabin interior side of the door 1 (i.e., the inside of the door 1) at a predetermined position on a forward side of the door 1.

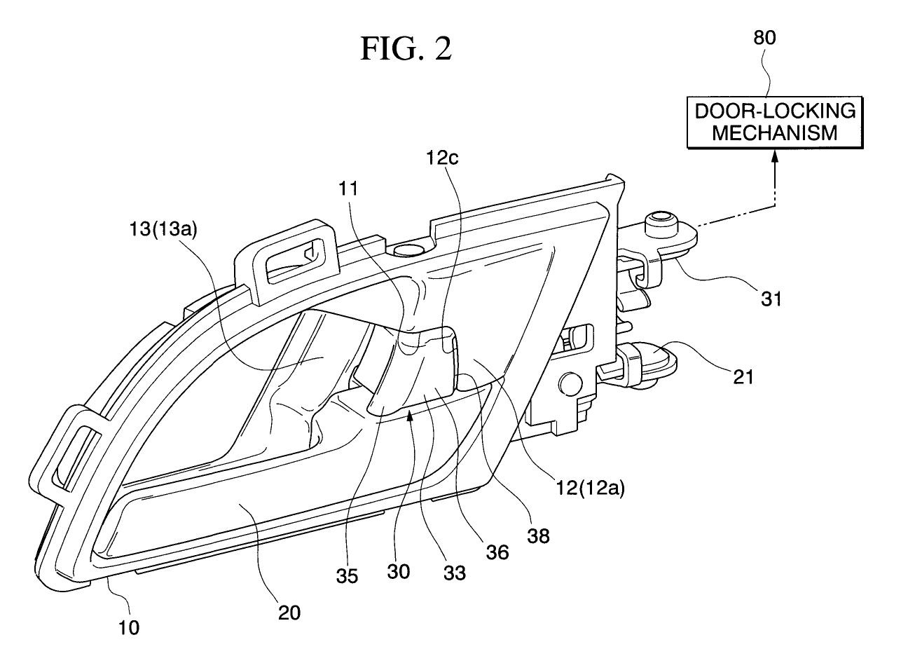

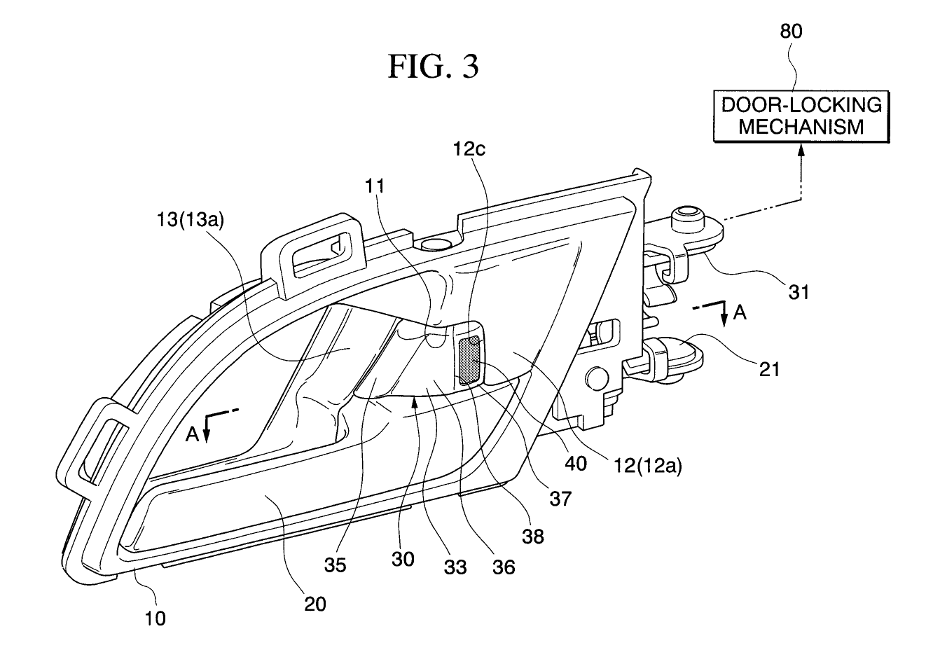

FIGS. 2 and 3 are perspective views of the inner handle case 10, the inner handle 20, and the door-locking knob 30. FIG. 2 shows the door-locking knob 30 in a locking position, while FIG. 3 shows the door-locking knob 30 in an unlocking position.

The inner handle 20 is installed in the lower half side of the inner handle case 10, so as to be rotatable in the horizontal direction. This inner handle 20 is linked via a handle rod 21 to a ratch of the door 1. By rotating the inner handle 20 from a neutral position shown in FIGS. 2 and 3 to the cabin interior side, engagement between the ratch of the door 1 and the striker provided on the vehicle body side is released to open the door 1. After this releasing operation and when the occupant releases the inner handle 20 from his/her own hand, the inner handle 20 automatically returns to the neutral position. Moreover, since the constructions of the door 1 and the striker on the vehicle body side are well known in this art, the explanations therefor will be omitted here.

The door-locking knob 30 is arranged so as to be rotatable in the horizontal direction, at the upper side than the inner handle 20 in the inner handle case 10.

The door-locking knob 30 is linked via a locking rod 31 to the door-locking mechanism 80. By setting the door-locking knob 30 to the locking position shown in FIG. 2, the door-locking mechanism 80 can be set to the locking state. On the other hand, by setting the door-locking knob 30 to the unlocking position shown in FIG. 3, the door-locking mechanism 80 can be set to the unlocking state. When the door-locking mechanism 80 is in the locking state, neither of an operation of the inner handle 20 nor an operation of an outer handle (not shown in the figures) provided on the cabin exterior side of the door 1 cannot release the engagement between the ratch and the striker. Therefore, in this state, the door 1 cannot be opened. On the other hand, when the door-locking mechanism 80 is in the unlocking state, the engagement between the ratch and the striker can be released by operating the inner handle 20 or the outer handle, and thereby enabling opening of the door 1. Moreover, since the door-locking mechanism 80 is well known in this art, and since any construction is acceptable if only it has the above-mentioned functions, the detailed explanation therefor will be omitted here.

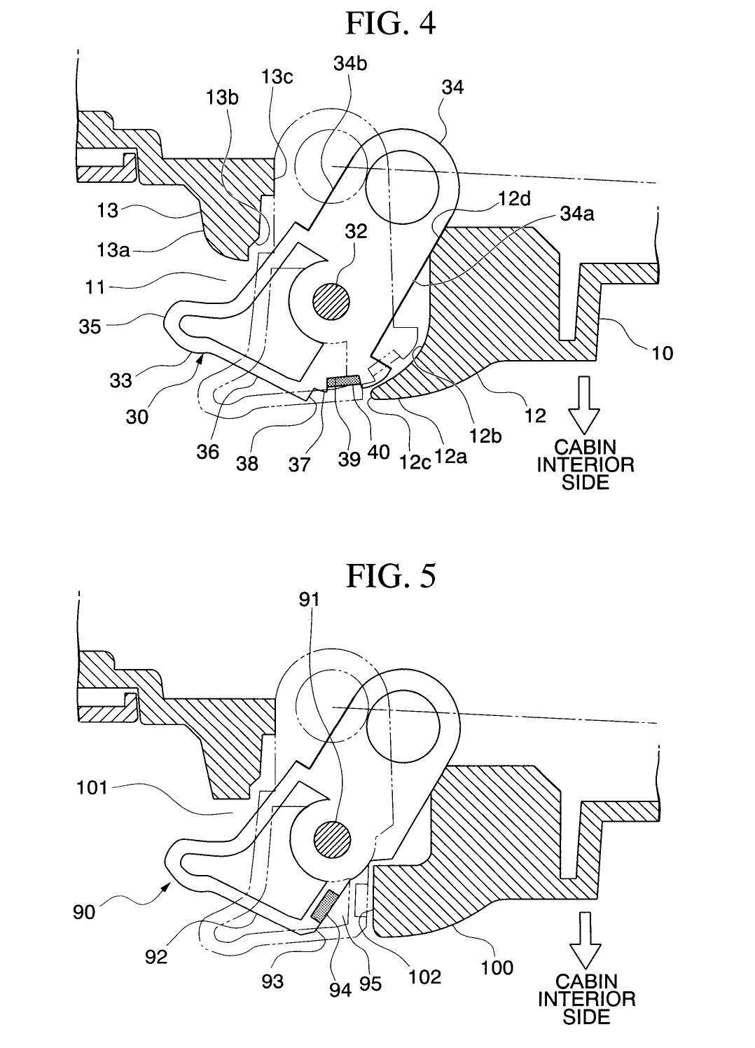

Characteristics of the present invention are in the installation construction of the door-locking knob 30 to the inner handle case 10, and the detailed explanation therefor will be mentioned below with reference to FIG. 4. Moreover, FIG. 4 is a cross-sectional view of a connection between the inner handle case 10 and the door-locking knob 30 on a horizontal cross-sectional plane (i.e., a cross-sectional view taking along a line A-A of FIG. 3).

The inner handle case 10 is formed with an opening 11 which exposes an operation portion 33 of the door-locking knob 30 to the cabin interior side. A rear side portion 12 of the inner handle case 10, which is arranged at more rearward than the opening 11 protrudes toward the cabin interior side than a front side portion 13 of the inner handle case 10, which is arranged at more forward than the opening 11.

A surface 12a of the rear side portion 12 is formed in a substantial arc shape. An inner face (clearance) 12b of the rear side portion 12, which is continuous with the surface 12a is also formed in a substantial arc shape having a smaller radius than that of the surface 12a. The surface 12a and the inner face 12b are smoothly connected with each other at a front edge 12c of the rear side portion 12 by a protruding arc surface. An unlocking engagement wall portion 12d is formed on a deep side portion of the inner face 12b in order to stop the door-locking knob 30 at the unlocking position thereof.

The surface 13a of the front side portion 13 is also formed in a substantial arc shape, while an inner face 13b which is continuous with the surface 13a is formed as a stepped face. A locking engagement wall portion 13c is formed on a deep side portion of the inner face 13b in order to stop the door-locking knob 30 at the locking position thereof.

The door-locking knob 30 is attached to the inner handle case 10 at a substantially center position of the opening 11 via a supporting pin 32 so as to be rotatable in the horizontal direction. The door-locking knob 30 is provided with an operation portion 33 which exposes while in a range from the locking position to the unlocking position, and an active portion 34 which does not expose at any positions of the door-locking knob 30. The supporting pin 32 penetrates a near of a boundary between the operation portion 33 and the active portion 34.

The above-mentioned locking rod 31 is joined with the active portion 34. The active portion 34 is formed with a rear side engagement face 34a and a front side engagement face 34b which are parallel with each other. When the door-locking knob 30 is turned to the unlocking position, the rear side engagement face 34a abuts the unlocking engagement wall portion 12d of the rear side portion 12 in the inner handle case 10, while when the door-locking knob 30 is turned to the locking position, the front side engagement face 34b abuts the locking engagement wall portion 13c of the front side portion 13 in the inner handle case 10. These operations prevent further rotations of the door-locking knob 30.

The operation portion 33 is formed with a finger-engagement portion 35 arranged at a front corner thereof, a lock face 36 which continuously extends rearward from the finger-engagement portion 35, and an unlock face 37 which continuously extends further rearward from the lock face 36.

The finger-engagement portion 35 is a portion to which the occupant engages his/her own finger in order to rotate the door-locking knob 30, and is formed in a suitable curved shape in order to realize preferable operability and preferable touch.

As indicated by two-dotted lines in FIG. 4, the lock face 36 is formed in a substantial planar face which is continuous with an extension of a tangential line of the surface 12a of the rear side portion 12 in the inner handle case 10 when the door-locking knob 30 is positioned to the locking position thereof. At the locking position, the lock face 36 is substantially continuous with the surface 12a of the rear side portion 12. A step portion 38 having the height of a slightly larger scale than that of the width of the forward end 12c of the rear side portion 12, is formed at a connection between the lock face 36 and the unlock face 37. At the locking position, the step portion 38 faces the front end 12c of the rear side portion 12, and thereby forming a small gap therebetween.

The unlock face 37 is dented in the cabin exterior with respect to the lock face 36 by the scale equivalent to the height of the step portion 38. The unlock face 37 is formed in an arc shape centering on a rotational center of the door-locking knob 30. As indicated by solid lines in FIG. 4, when the door-locking knob 30 is turned to the unlocking position, the most part of the unlock face 37 is exposed toward the cabin interior side from the opening 11 of the inner handle case 10 (i.e., the surface side of the inner handle case 10).

The dented portion 39 having the size of covering the most part of the exposed portion is provided at a center of the unlock face 37 which exposes through the opening 11 at the unlocking position. A marking 40 is attached into the dented portion 39, that indicates that the door-locking knob 30 is positioned at the unlocking position. The marking 40 faces the cabin interior side while in the unlocking position, has a planar surface, and is colored with high visibility color (for example, red).

In addition, the inner face 12b of the rear side portion 12 in the inner handle case 10 is formed in an arc shape having a slightly larger radius than that of the unlock face 37, and is also formed in an interference-preventing shape formed along the rotational trajectory of the unlock face 37 so as not to interfere with the unlock face 37 while rotating the door-locking knob 30.

The gap formed between the unlock face 37 and the inner face 12b is set so as to have an extremely small and predetermined scale (for example, within a range from equal to or more than 0.5 mm to equal to or less than 1.5 mm, and more preferably, about 1 mm) in a rotational range between the locking position and the unlocking position.

According to the door-locking knob construction of a vehicle explained in the above, while rotating the door-locking knob 30 to the unlocking position, the gap between the lock face 36 of the door-locking knob 30 and the rear side portion 12 of the inner handle case 10 is closed by the unlock face 37 arranged so as to be almost continuous with the inner face 12b of the rear side portion 12. As a result, there is no possibility of sandwiching an object therebetween, and therefore, it is possible to prevent the object sandwiched between the door-locking knob 30 and the inner handle case 10 while switching the door-locking knob 30 from the unlocking position to the locking position.

In addition, the marking 40 provided on the unlock face 37 faces the cabin interior side while the door-locking knob 30 is in the unlocking position, and is formed so as to have a planar surface; therefore, the driver (or the occupant) can identify the marking 40 while facing it. Furthermore, the surface of the marking 40 has the color having the high visibility. As the result, the visibility of the marking 40 increases, and the driver (or the occupant) can reliably distinguish whether the door-locking mechanism 80 is in the locking state or in the unlocking state.

Furthermore, the inner face 12b of the rear side portion 12 in the inner handle case 10 is formed in the arc shape having the slightly larger radius than that of the unlock face 37, and is also formed in the interference-preventing shape formed along the rotational trajectory of the unlock face 37 so as not to interfere with the unlock face 37 while rotating the door-locking knob 30. Therefore, it is possible to form the extremely small gap portion continuously between the unlock face 37 and the inner face 12b of the rear side portion 12. Thus, it is possible to prevent light getting into the gap, and thereby making the inside of the gap invisible. Accordingly, the commercial value thereof can be increased.

Moreover, the present invention is not limited only to the above-mentioned embodiment.

For example, the door is not limited to that on the driver's seat side, and may be that on the assistant driver's seat side or those on the rear seat sides.

While a preferred embodiment of the invention has been described and illustrated above, it should be understood that this is an exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A door-locking knob construction of a vehicle, provided in an inside of a vehicular door, wherein:
a door-locking knob is rotationally provided in a knob-installation portion inside the vehicular door, and switches between a locking and an unlocking of a door-locking mechanism in accordance with a rotational position thereof;
the door-locking knob comprises a lock face which is continuous with a surface of the knob-installation portion while in a locking position, and an unlock face which is continuous with the lock face and is exposed to the same side as the surface of the knob-installation portion while in an unlocking position;
the unlock face is formed in a substantial arc shape centering on a rotational axis of the door-locking knob; and
a gap between the knob-installation portion and the unlock face is maintained to be a predetermined small width, in a rotational range between the locking position and the unlocking position.

2. The door-locking knob construction of a vehicle according to claim 1, wherein:
the unlock face comprises a marking thereon which indicates the unlocking position; and
the marking faces a cabin interior side when the door-locking knob is in the unlocking position.

3. The door-locking knob construction of a vehicle according to claim 2, wherein
the marking is provided in a dented portion provided in the unlock face, and has a planar surface.

4. The door-locking knob construction of a vehicle according to claim 1, wherein
the knob-installation portion has a clearance which is formed along a rotational trajectory of the unlock face.

5. The door-locking knob construction of a vehicle according to claim 1, wherein
the predetermined small width is within a range between 0.5 mm to 1.5 mm.
